(19) United States
(12) Patent Application Publication
(10) Pub. No.: US 2016/0255579 A1
(43) Pub. Date: Sep. 1, 2016

(54) BASE STATION, PROCESSOR AND TERMINAL

(71) Applicant: KYOCERA CORPORATION, Kyoto-shi, Kyoto (JP)

(72) Inventors: Fangwei TONG, Machida-shi,Tokyo (JP); Hiroyuki ADACHI, Kawasaki-shi, Kanagawa (JP); Chiharu YAMAZAKI, Ota-ku,Tokyo (JP); Kugo MORITA, Yokohama-shi, Kanagawa (JP)

(73) Assignee: KYOCERA CORPORATION, Kyoto (JP)

(21) Appl. No.: 15/030,947

(22) PCT Filed: Oct. 16, 2014
(86) PCT No.: PCT/JP2014/077553

§ 371 Date: Apr. 21, 2016

(30) Foreign Application Priority Data
Oct. 21, 2013 (JP) 2013-218423

(51) Int. Cl. H04W 52/02; H04L 1/00; H04L 5/00; H04W 52/42

(52) U.S. Cl. CPC H04W 52/0206; H04W 52/42; H04L 1/0003; H04L 5/0048; H04W 88/08

(57) ABSTRACT

A base station according to one embodiment is a base station managing a cell. The base station comprises a transmitter configured to be capable of transmitting, with a first transmission power, predetermined information to a user terminal connected with the cell, and a controller configured to control the base station. When an amount or a ratio of an unassigned resource exceeds a threshold value, the unassigned resource being a radio resource capable of being used for transmitting the predetermined information and being not yet assigned to a terminal, the controller performs, with a second transmission power lower than the first transmission power, redundant transmission control in which the predetermined information is redundantly transmitted by using the unassigned resource. The predetermined information is control information or user data.

### TECHNICAL FIELD

The present invention relates to a base station and a processor used in a mobile communication system.

### BACKGROUND ART

According to 3GPP (3rd Generation Partnership Project), which is a project aiming to standardize a mobile communication system, a technology for energy saving, which reduces power consumption of a base station, has been discussed (for example, see Non Patent Literature 1). By stopping operation of a cell of a base station, for example, in the nighttime when communication traffic is less, for example, it is possible to reduce power consumption of the base station.

### CITATION LIST

### Non Patent Literature

[NPL 1] 3GPP technical report “TR 36.927 V11.0.0” September, 2012

### SUMMARY OF INVENTION

However although it is possible to reduce power consumption of the base station by stopping the operation of the cell managed by the base station, a user terminal that has been connected with the cell becomes not possible to communicate with the cell, and thus, communication quality of the user terminal may deteriorate.

Thus, an object of the present invention is to realize power saving of a base station while suppressing a decrease in communication quality.

A base station according to one embodiment is a base station managing a cell. The base station comprises a transmitter configured to be capable of transmitting, with a first transmission power, predetermined information to a user terminal connected with the cell, and a controller configured to control the base station. When an amount or a ratio of an unassigned resource exceeds a threshold value, the unassigned resource being a radio resource capable of being used for transmitting the predetermined information and being not yet assigned to a terminal, the controller performs, with a second transmission power lower than the first transmission power, redundant transmission control in which the predetermined information is redundantly transmitted by using the unassigned resource. The predetermined information is control information or user data.

A processor according to one embodiment is a processor for controlling a base station that manages a cell. The processor is capable of controlling to transmit, with a first transmission power, predetermined information that is control information or user data to a user terminal connected with the cell. When an amount or a ratio of an unassigned resource exceeds a threshold value, the unassigned resource being a radio resource capable of being used for transmitting the predetermined information, the processor performs, with a second transmission power lower than the first transmission power, redundant transmission control in which the predetermined information is redundantly transmitted by using the unassigned resource.

A terminal according to one embodiment is a terminal connected to a cell managed by a base station. The terminal comprise: a receiver configured to receive redundant transmission information transmitted from the base station, and the receiver receives on the basis of the received redundant transmission information, predetermined information redundantly transmitted from the base station.

### BRIEF DESCRIPTION OF DRAWINGS

FIG. 1 is a configuration diagram of an LTE system.

FIG. 2 is a block diagram of a UE.

FIG. 3 is a block diagram of an eNB.

FIG. 4 is a protocol stack diagram of a radio interface in the LTE system.

FIG. 5 is a configuration diagram of a radio frame used in the LTE system.

FIGS. 6(A) and 6(B) are explanatory diagrams for describing an operation overview of a mobile communication system according to an embodiment.

FIG. 7 is an explanatory diagram for describing one example of an operation of an eNB 200 according to the embodiment.

FIG. 8 is an explanatory diagram for describing one example of an operation of the eNB 200 according to a first modification of the present embodiment.

FIG. 9 is an explanatory diagram for describing one example of an operation of the eNB 200 according to another embodiment.

### DESCRIPTION OF EMBODIMENTS

A base station according to embodiments is a base station managing a cell. The base station comprises a controller which is capable of controlling to transmit, with a first transmission power, predetermined information that is control information or user data to a user terminal connected with the cell. When an amount or a ratio of an unassigned resource exceeds a threshold value, the unassigned resource being a radio resource capable of being used for transmitting the predetermined information, the controller performs, with a second transmission power lower than the first transmission power, redundant transmission control in which the predetermined information is redundantly transmitted by using the unassigned resource, instead of transmitting the predetermined information with the first transmission power.

In the embodiments, the controller determines, in accordance with the amount of unassigned resource, a value of the second transmission power.

In the embodiments, the controller performs control of transmitting the predetermined information in a duplicate manner, or control of transmitting, by using an error correction code, the predetermined information in which the level of redundancy is increased than the predetermined information transmitted with the first transmission power.

In other embodiments, when a radio resource previously assigned to the user terminal for transmitting the predetermined information, and a radio resource assigned to the user terminal, out of the unassigned resource are located within one subframe, the controller performs, as the redundant transmission control, control of decreasing a value associated with an MCS and transmitting the predetermined information.

In the embodiments, the controller performs control of transmitting, before the redundant transmission is started, redundant transmission information used for the user terminal to perform composite reception of and/or decode the redundantly transmitted predetermined information, to the user terminal.

In the embodiments, the redundant transmission information includes information indicating a method of the redundant transmission control and/or information indicating a radio resource assigned to the user terminal, out of the unassigned resource.

In the embodiments, the controller transmits a reference signal for a downlink channel estimation with a third transmission power lower than a transmission power used when the redundant transmission control is not performed. When receiving channel quality information based on the reference signal transmitted with the third transmission power from the user terminal, the controller determines, on the basis of the third transmission power together with the channel quality information, an MCS for the redundant transmission control.

In the embodiments, when a plurality of user terminals including the user terminal are connected with the cell, the controller divides the plurality of user terminals into a plurality of groups, in accordance with each pathloss to each of the plurality of user terminals from the base station. The controller determines a value of the second transmission power in each of the plurality of groups and/or a method of the redundant transmission control therein.

In the embodiments, when the number of user terminals that start connection with the cell and/or the number of user terminals that end communication with the base station exceed a threshold value, the controller newly determines a value of the second transmission power and/or and a method of the redundant transmission control.

A processor according to the embodiments is a processor provided in a base station managing a cell. The processor comprises a controller which is capable of controlling to transmit, with a first transmission power, predetermined information which is control information or user data to a user terminal connected with the cell. When an amount or a ratio of an unassigned resource exceeds a threshold value, the unassigned resource being a radio resource capable of being used for transmitting the predetermined information, the controller performs, with a second transmission power lower than the first transmission power, redundant transmission control in which the predetermined information is redundantly transmitted by using the unassigned resource, instead of transmitting the predetermined information with the first transmission power.

### Embodiments

### LTE System

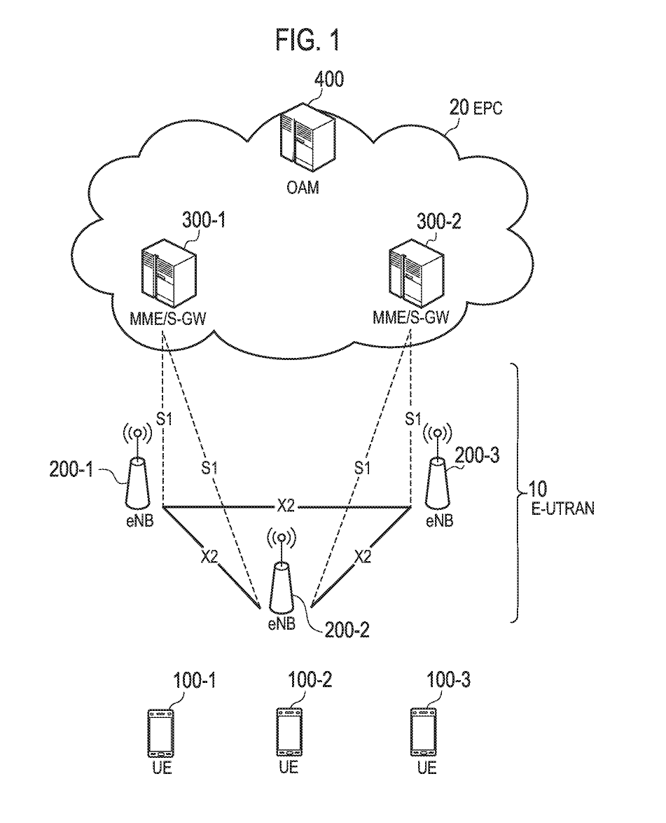

FIG. 1 is a configuration diagram of an LTE system according to a present embodiment.

As shown in FIG. 1, the LTE system includes a plurality of UEs (User Equipments) 100, E-UTRAN (Evolved Universal Terrestrial Radio Access Network) 10, and EPC (Evolved Packet Core) 20. The E-UTRAN 10 and the EPC 20 constitute a network.

The UE 100 is a mobile radio communication device and performs radio communication with a cell (a serving cell) with which a connection is established. The UE 100 corresponds to the user terminal.

The E-UTRAN 10 includes a plurality of eNBs 200 (evolved Node-Bs). The eNB 200 corresponds to a base station. The eNB 200 manages a cell and performs radio communication with the UE 100 that establishes a connection with the cell.

It is noted that the “cell” is used as a term indicating a minimum unit of a radio communication area, and is also used as a term indicating a function of performing radio communication with the UE 100.

The eNB 200, for example, has a radio resource management (RRM) function, a function of routing user data, and a measurement control function for mobility control and scheduling.

The EPC 20 includes MME (Mobility Management Entity)/S-GW (Serving-Gateway) 300 and OAM (Operation and Maintenance) 400. Further, the EPC 20 corresponds to a core network.

The MME is a network node that performs various mobility controls and the like, for the UE 100 and corresponds to a controller. The S-GW is a network node that performs control to transfer user data and corresponds to a mobile switching center.

The eNBs 200 are connected mutually via an X2 interface. Furthermore, the eNB 200 is connected to the MME/S-GW 300 via an S1 interface.

The OAM 400 is a server device managed by an operator and performs maintenance and monitoring of the E-UTRAN 10.

Next, configurations of the UE 100 and the eNB 200 will be described.

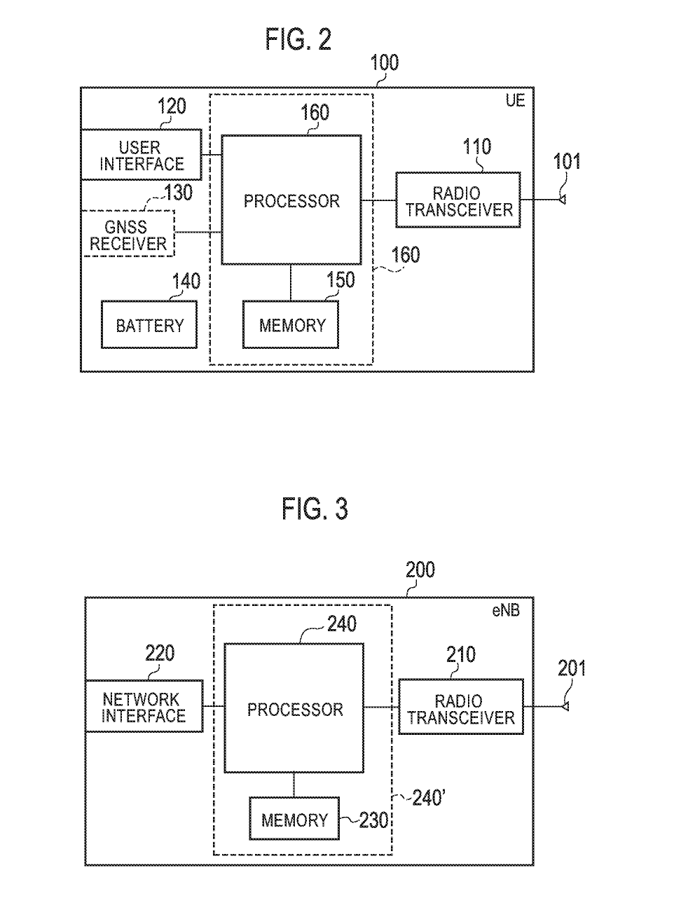

FIG. 2 is a block diagram of the UE 100. As shown in FIG. 2, the UE 100 includes an antenna 101, a radio transceiver 110, a user interface 120, GNSS (Global Navigation Satellite System) receiver 130, a battery 140, a memory 150, and a processor 160. The memory 150 and the processor 160 configure a controller.

The UE 100 may not have the GNSS receiver 130. Furthermore, the memory 150 may be integrally formed with the processor 160, and this set (that is, a chip set) may be called a processor 160′.

The antenna 101 and the radio transceiver 110 are used to transmit and receive a radio signal. The antenna 101 includes a plurality of antenna elements. The radio transceiver 110 converts a baseband signal output from the processor 160 into the radio signal, and transmits the radio signal from the antenna 101. Furthermore, the radio transceiver 110 converts the radio signal received by the antenna 101 into the baseband signal, and outputs the baseband signal to the processor 160.

The user interface 120 is an interface with a user carrying the UE 100, and includes, for example, a display, a microphone, a speaker, various buttons and the like. The user interface 120 receives an operation from a user and outputs a signal indicating the content of the operation to the processor 160.

The GNSS receiver 130 receives a GNSS signal in order to obtain location information indicating a geographical location of the UE 100, and outputs the received signal to the processor 160.

The battery 140 accumulates a power to be supplied to each block of the UE 100.

The memory 150 stores a program to be executed by the processor 160 and information to be used for a process by the processor 160.

The processor 160 includes a baseband processor that performs modulation and demodulation, encoding and decoding and the like on the baseband signal, and a CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As shown in FIG. 3, the eNB 200 includes an antenna 201, a radio transceiver 210, a network interface 220, a memory 230, and a processor 240. The memory 230 and the processor 240 constitute a contoller. In addition, the memory 230 is integrated with the processor 240, and this set (that is, a chipset) may be called a processor 240′.

The antenna 201 and the radio transceiver 210 are used to transmit and receive a radio signal. The antenna 201 includes a plurality of antenna elements. The radio transceiver 210 converts the baseband signal output from the processor 240 into the radio signal, and transmits the radio signal from the antenna 201. Furthermore, the radio transceiver 210 converts the radio signal received by the antenna 201 into the baseband signal, and outputs the baseband signal to the processor 240.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for a process by the processor 240.

The processor 240 includes the baseband processor that performs modulation and demodulation, encoding and decoding and the like on the baseband signal and a CPU that performs various processes by executing the program stored in the memory 230. The processor 240 executes various processes and various communication protocols described later.

In the embodiments, the controller is capable of controlling to transmit, with a normal transmission power (first transmission power), predetermined information to the UE 100. Furthermore, the controller is capable of performing, with a low transmission power (second transmission power) lower than the normal transmission power, redundant transmission control in which the predetermined information is redundantly transmitted by using the unassigned resource.

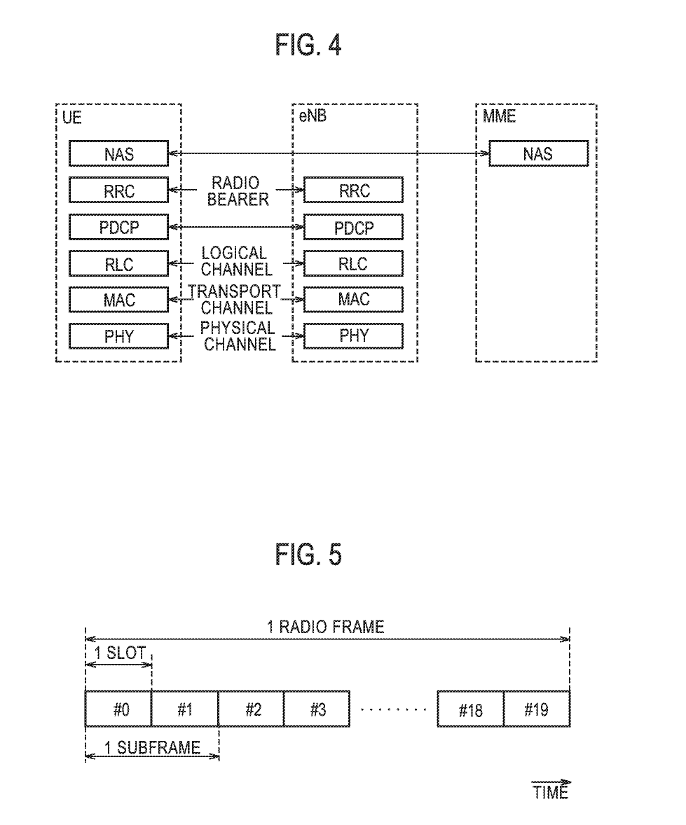

FIG. 4 is a protocol stack diagram of a radio interface in the LTE system.

As shown in FIG. 4, the radio interface protocol is classified into a layer 1 to a layer 3 of an OSI reference model, wherein the layer 1 is a physical (PHY) layer. The layer 2 includes MAC (Media Access Control) layer, RLC (Radio Link Control) layer, and PDCP (Packet Data Convergence Protocol) layer. The layer 3 includes RRC (Radio Resource Control) layer.

The PHY layer performs encoding and decoding, modulation and demodulation, antenna mapping and demapping, and resource mapping and demapping. The PHY layer provides a transmission service to an upper layer by using a physical channel. Between the PHY layer of the UE 100 and the PHY layer of the eNB 200, data is transmitted through the physical channel.

The MAC layer performs priority control of data, and a retransmission process and the like by hybrid ARQ (HARQ). Between the MAC layer of the UE 100 and the MAC layer of the eNB 200, data is transmitted via a transport channel. The MAC layer of the eNB 200 includes a transport format of an uplink and a downlink (a transport block size, a modulation and coding scheme and the like) and a MAC scheduler to decide a resource block to be assigned.

The RLC layer transmits data to an RLC layer of a reception side by using the functions of the MAC layer and the PHY layer. Between the RLC layer of the UE 100 and the RLC layer of the eNB 200, data is transmitted via a logical channel.

The PDCP layer performs header compression and decompression, and encryption and decryption.

The RRC layer is defined only in a control plane. Between the RRC layer of the UE 100 and the RRC layer of the eNB 200, a control signal (an RRC message) for various types of setting is transmitted. The RRC layer controls the logical channel, the transport channel, and the physical channel in response to establishment, re-establishment, and release of a radio bearer. When an RRC connection is established between the RRC of the UE 100 and the RRC of the eNB 200, the UE 100 is in a connected state, and when the RRC connection is not established, the UE 100 is in an idle state.

NAS (Non-Access Stratum) layer positioned above the RRC layer performs session management, mobility management and the like.

FIG. 5 is a configuration diagram of a radio frame used in the LTE system. In the LTE system, OFDMA (Orthogonal Frequency Division Multiplexing Access) is employed in a downlink, and SC-FDMA (Single Carrier Frequency Division Multiple Access) is employed in an uplink, respectively.

As shown in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each symbol is provided at a head thereof with a guard interval called a cyclic prefix (CP). The resource block includes a plurality of subcarriers in the frequency direction. A radio resource unit configured by one subcarrier and one symbol is called a resource element (RE).

Among radio resources assigned to the UE 100, a frequency resource can be designated by a resource block and a time resource can be designated by a subframe (or slot).

In the downlink, an interval of several symbols at the head of each subframe is a control region mainly used as a physical downlink control channel (PDCCH). Furthermore, the remaining interval of each subframe is a region that can be mainly used as a physical downlink shared channel (PDSCH). Moreover, in each subframe, cell-specific reference signals (CRSs) are distributed and arranged.

In the uplink, both ends in the frequency direction of each subframe are control regions mainly used as a physical uplink control channel (PUCCH). Furthermore, the center portion in the frequency direction of each subframe is a region that can be mainly used as a physical uplink shared channel (PUSCH). Moreover, in each subframe, a demodulation reference signal (DMRS) and a sounding reference signal (SRS) are arranged.

(Operation According to Embodiment)

(1) Operation Overview

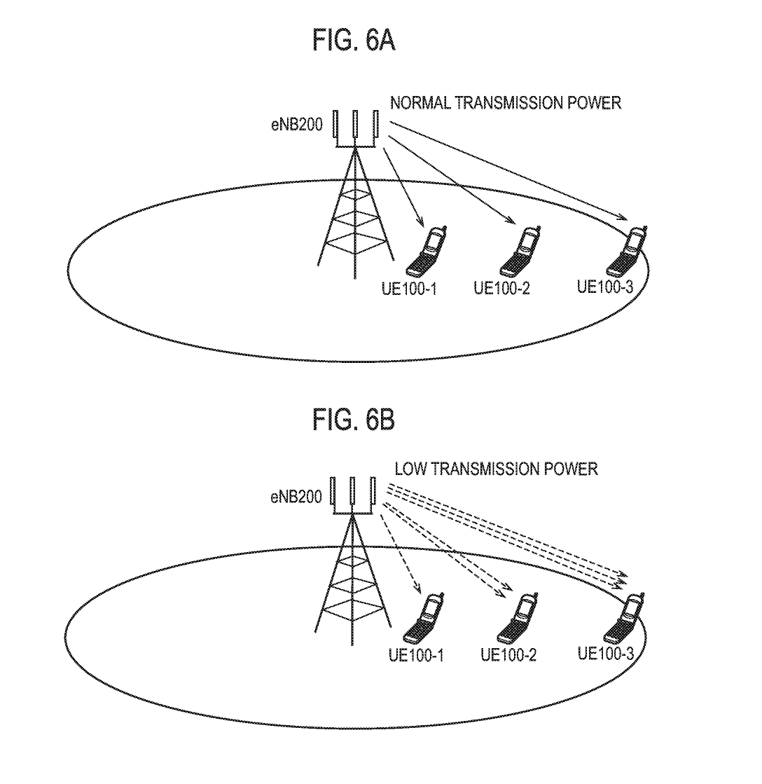

Next, an operation overview of the mobile communication system according to the present embodiment will be described by using FIGS. 6(A) and 6(B). FIGS. 6(A) and 6(B) are explanatory diagrams for describing the operation overview of the mobile communication system according to the embodiment. Specifically, FIG. 6(A) is an explanatory diagram showing a case where the eNB 200 transmits the user data by a normal control. FIG. 6(B) is an explanatory diagram showing a case where the eNB 200 transmits the user data by a redundant transmission control.

Firstly, the case where the eNB 200 transmits the user data by the normal control will be described.

As shown in FIG. 6(A), the mobile communication system according to the present embodiment has a UE 100-1, a UE 100-2, a UE 100-3, and an eNB 200. The eNB 200 manages a cell, and each UE 100 (the UE 100-1, the UE 100-2, and the UE 100-3) is connected to the cell. Therefore, each UE 100 is in a connected state (RRC connection state). The UE 100-1 is located near a center side of the cell, the UE 100-3 is located at the end of the cell, and the UE 100-2 is located between the UE 100-1 and the UE 100-3.

When performing the normal control, the eNB 200 transmits the user data to each UE 100 connected with the cell (see FIG. 6(A)).

In this case, the eNB 200 uses a radio resource assigned to each UE 100 to transmit the user data with a normal transmission power. In the present embodiment, the normal transmission power is previously fixed transmission power, that is, a transmission power defined when an operator designs a cell of the eNB 200.

Next, the case where the eNB 200 transmits the user data by the redundant transmission control will be described.

When performing the redundant transmission control, the eNB 200 redundantly transmits the user data to each UE 100 with a transmission power lower than the normal transmission power (low transmission power) (see FIG. 6(B)). The eNB 200 uses the radio resource assigned during transmission with the normal transmission power, and in addition, uses a surplus radio resource (unassigned resource described later) to redundantly transmit the user data.

For example, the eNB 200 transmits the user data to each UE 100 with a transmission power one third the normal transmission power. Instead thereof, the eNB 200 transmits, to the UE 100-2 and the UE 100-3 apart from the eNB 200, the user data by using the surplus radio resource. For example, the eNB 200 performs double transmission of the user data to the UE 100-2, and performs triple transmission of the user data to the UE 100-3. On the other hand, the eNB 200 may transmit, to the UE 100-1 near the eNB 200, the user data by using only the radio resource used for the normal transmission.

Even when the user data is transmitted with the low transmission power, the UE 100-2 and the UE 100-3 apply diversity synthesis to the user data transmitted in a duplicate manner to thereby decode the user data.

The eNB 200 decreases the power corresponding to a diversity gain to transmit the user data to each UE 100. For example, when the double transmission of the user data is performed, half the transmission power, which corresponds to a diversity gain of 3 dB, is used to transmit the user data.

It is noted that rather than the duplicate transmission, the eNB 200 may transmit the user data having a higher error correction capability than the normal transmission by using the surplus radio resource. Even when the user data is transmitted with the low transmission power, each UE 100 may perform an error correction process to decode the user data.

(2) Operation Sequence

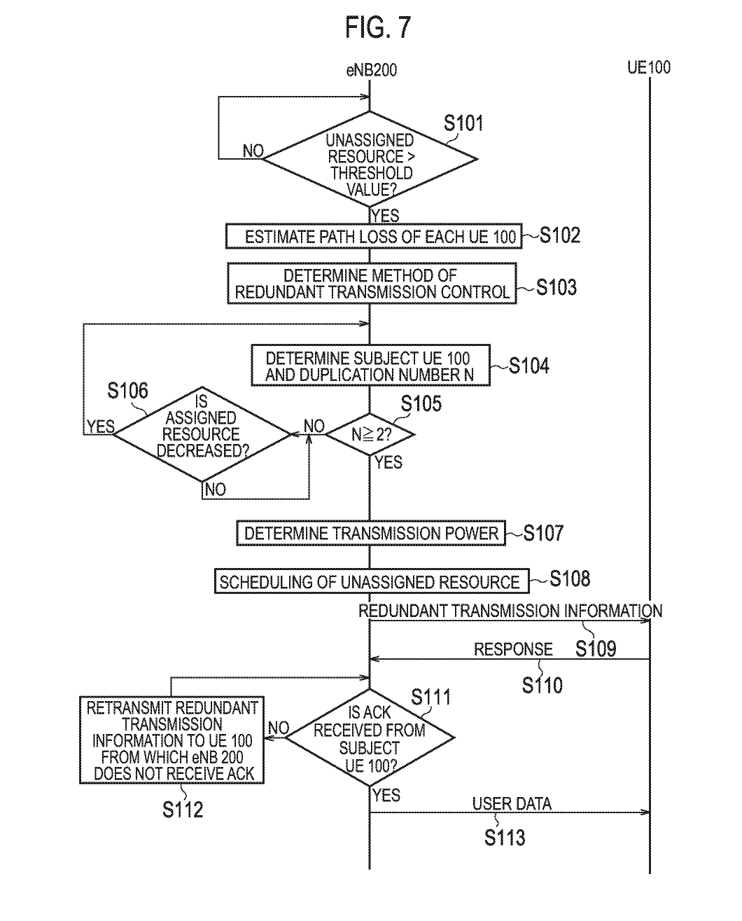

Next, an operation sequence of the eNB 200 according to the present embodiment will be described by using FIG. 7. FIG. 7 is an explanatory diagram for describing one example of an operation of the eNB 200 according to the present embodiment.

For simplicity, description proceeds with an assumption that only the above-described UE 100-1 and UE 100-3 are connected with the cell, below.

As shown in FIG. 7, in step S101, the eNB 200 determines whether or not an amount of unassigned resource that is a radio resource to be used for transmitting the user data exceeds a threshold value. After performing scheduling in which the radio resource is assigned for transmitting the user data, the eNB 200 performs the above-described determination. It is noted that when the radio resource is assigned in a semi-fixed manner by a semi-persistent scheduling, the eNB 200 may perform the above-described determination.

Firstly, the eNB 200 calculates an amount of unassigned resource that is the radio resource to be used for transmitting the user data. The unassigned resource may be a radio resource not yet assigned within a predetermined range (unit of 5 ms, for example).

Next, the eNB 200 compares the calculated unassigned resource amount with a threshold value. The threshold value may be a fixed value, and may be a value varying, for example, in accordance with the number of UEs 100 connected with the cell.

When determining that the amount of unassigned resource does not exceed the threshold value (when “NO”), the eNB 200 repeats the process in step S101. On the other hand, when determining that the amount of unassigned resource exceeds the threshold value (when “YES”), the eNB 200 executes a process in step S102.

It is noted that the eNB 200 may calculate a ratio of an unassigned resource relative to total radio resources (sum of the assigned resource and the unassigned resource) (unassigned resource/total radio resources) to compare, instead of the amount of unassigned resource, the ratio of the unassigned resource with the threshold value.

In step S102, the eNB 200 estimates a pathloss from the eNB 200 to the UE 100. The eNB 200 estimates the pathloss, for example, by using a method (a) or (b) below.

(a) Received Power

The eNB 200 calculates (estimates) the pathloss of the UE 100 from a difference between transmission power of a signal transmitted from the eNB 200 and a received power of the signal received by the UE 100. Alternatively, the eNB 200 calculates (estimates) the pathloss of the UE 100 from a difference between transmission power of a signal transmitted by the UE 100 and a received power of the signal received by the eNB200.

(b) Location Information

Firstly, the eNB 200 acquires the location information of the UE 100. The eNB 200 may receive the location information from the UE 100, and may acquire the location information by querying the network. The eNB 200 identifies the location of the UE 100 by the location information.

Next, on the basis of the location of the eNB 200 and that of the UE 100, the eNB 200 calculates a distance between the eNB 200 and the UE 100. The eNB 200 estimates the pathloss in accordance with the calculated distance.

It is noted that the eNB 200 may calculate a propagation delay time from a timing advance (TA) of the UE 100 used in adjustment of a transmission timing in an uplink, and calculate the distance between the eNB 200 and the UE 100 from the calculated propagation delay time and a propagation speed of an uplink signal from the UE 100.

The eNB 200 estimates the pathloss of each UE 100 in step S102, and then, performs a process in step S103.

In step S103, the eNB 200 determines the method of the redundant transmission control. The eNB 200 determines to perform the redundant transmission control by at least either one of the following (a) or (b), for example.

(a) Redundant Transmission by Duplicate Transmission

The eNB 200 transmits the user data in a duplicate manner to perform the redundant transmission. For example, in addition to the normal transmission of the user data, the eNB 200 transmits the user data in accordance with the duplication number N described later. In this case, the eNB 200 may update a redundant version (RV) at each transmission of the user data. Further, the eNB 200 may regard, as retransmission of the user data, second and subsequent transmissions of the user data by not updating (inverting) a new data indicator (NDI).

Further, the eNB 200 may transmit the user data (replica data) that has been transmitted once as if to transmit new user data.

(b) Redundant Transmission by Adjustment of MCS

The eNB 200 performs the redundant transmission by decreasing a value associated with an MCS (Modulation and Coding Scheme) and transmitting the user data in which a modulation method and/or a coding rate is changed.

For example, when the modulation scheme in the normal transmission is 16 QAM, the eNB 200 determines a value associated with the MCS so that the modulation scheme in the redundant transmission is QPSK.

Further, the eNB 200 may determine the value associated with the MCS, in accordance with an E-SINR calculated by adding a correction value to an E-SINR (Effective SINR) evaluated from a CQI reported from the UE 100. Here, the correction value is a value (−3 dB, for example) so that the calculated E-SINR is lower in communication quality than the E-SINR evaluated from the CQI.

Further, when changing the coding rate, the eNB 200 is capable of using an error correction code to transmit the user data in which the level of redundancy is increased than the user data transmitted with the normal transmission power. Specifically, the eNB 200 is capable of performing the redundant transmission by using the error correction code, in accordance with the following method.

Firstly, the eNB 200 uses, on raw data of the user data, the error correction code higher in error correction capability than the error correction code used for the normal transmission to perform the redundant transmission.

For example, it is assumed that the eNB 200 normally uses a predetermined amount of radio resources to transmit the user data obtained through multiplication by a turbo code in which the coding rate is one third. When performing the redundant transmission, the eNB 200 uses twice the predetermined amount of the radio resource to transmit the user data obtained through multiplication by a turbo code in which the coding rate is one sixth.

Further, the eNB 200 may perform the redundant transmission by decreasing the coding rate, and in addition thereto, may perform the redundant transmission by changing a kind of the error correction code between the normal transmission and the redundant transmission.

Secondly, the eNB 200 performs the redundant transmission by further multiplying the user data obtained through previous multiplication by an error correction code, by an error correction code.

For example, the eNB 200 performs the redundant transmission by further multiplying the user data obtained through multiplication by an error correction code used in the normal transmission, with an error correction code.

In the present embodiment, description proceeds with an assumption that the eNB 200 determines to perform the redundant transmission by the duplicate transmission.

In step S104, the eNB 200 determines the UE 100 subject to the redundant transmission and the duplication number N so that an amount of resources used for the redundant transmission is contained within a range of the amount of unassigned resource. Here, the duplication number N indicates the number by which the user data is transmitted in a duplicate manner.

The eNB 200 divides a plurality of UEs 100 into a plurality of groups in accordance with each pathloss of a plurality of UEs 100 (the UE 100-1 and the UE 100-2) connected to the cell. For example, when dividing the plurality of UEs 100 into two groups, the eNB 200 categorizes the UE 100 having the pathloss that satisfies the following formula (1) into a first group (G1), and categorizes the UE 100 having the pathloss that satisfies the following formula (2) into a second group (G2).

L<Lmax/N formula (1)

L≧Lmax/N formula (2)

L: pathloss of UE 100/Lmax: maximum pathloss/N: duplication number

It is noted that Lmax is equal to the pathloss of the UE 100 located at a cell edge, for example. When the pathloss of the UE 100 is written in decibel (dB), the UE 100 is categorized into two groups according to the following formulas (1)′ and (2)′.

L<Lmax−10 ln(N) formula (1)′

L≧Lmax−10 ln(N) formula (2)′

The eNB 200 temporarily determines the duplication number N (temporarily determines it as 3, for example), and categorizes each UE 100 into two groups. The eNB 200 categorizes a plurality of UEs 100, and then, stores the number of UEs 100 of each group.

In the present embodiment, it is assumed that the eNB 200 categorizes the UE 100-1 into the first group G1, and categorizes the UE 100-3 into the second group G2. Further, description proceeds with an assumption that the eNB 200 determines to not perform the redundant transmission on the UE 100 belonging to the first group G1 (that is, the UE 100-1), but perform the redundant transmission by the duplicate transmission on the UE 100 belonging to the second group G2 (that is, the UE 100-3).

Next, the eNB 200 determines whether or not the temporarily determined duplication number N (that is, 3) satisfies, for example, the following formula (3).

$$\begin{matrix}[ Formula 3 ] & \\ N < \frac{ρ R}{{\sum }_{i = 1}^{M} ri} + 1 & [ Formula 3 ]\end{matrix}$$

N: duplication number/p: marginal coefficient (0<ρ<1, for example)/R: amount of unassigned resource/M: the number of UEs 100 belonging to second group/ri: amount of radio resource previously assigned to i-th UE 100 in second group

When the duplication number N satisfies the formula (3), the eNB 200 determines that the amount of resource used for the redundant transmission is contained within a range of the amount of unassigned resource, and determines, as the official duplication number N, the temporarily determined duplication number N. On the other hand, when the duplication number N does not satisfy the formula (3), the eNB 200 changes the duplication number N and uses the formulas (1) and (2) to categorize again the UEs 100 into a new group, and then, determines whether or not the formula (3) is satisfied. The eNB 200 repeats this operation until the official duplication number N that satisfies the formula (3) is determined.

In step S105, the eNB 200 determines whether or not the determined duplication number N is equal to or more than 2. When the duplication number N is equal to or more than two, the eNB 200 executes a process of step S107. On the other hand, when the overlapping number N is less than 2, the eNB 200 executes a process of step S106.

In step S106, the eNB 200 determines whether or not the amount of assigned resource that is the radio resource already assigned to each UE 100 decreases. When determining that the amount of assigned resource decreases (when “YES”), the eNB 200 executes a process in step S104. On the other hand, when the amount of assigned resource does not decrease (when “NO”), the eNB 200 repeats the process in step S106.

It is noted that rather than determining whether or not the amount of assigned resource decreases, the eNB 200 may determine whether or not a ratio (assigned resource/total radio resources) of the assigned resource relative to total radio resources (sum of the assigned resource and the unassigned resource) decreases. When the ratio decreases, the eNB 200 executes the process in step S104, and when the ratio does not decrease, the eNB 200 may repeat the process in step S106.

Alternatively, the eNB 200 may determine whether or not the amount or the ratio of unassigned resource (unassigned resource/total radio resources) increases. When the amount or the ratio of unassigned resource increases, the eNB 200 executes the process in step S104, and when the amount or the ratio of unassigned resource does not increase, the eNB 200 may repeat the process in step S106.

In step S107, the eNB 200 determines transmission power (value) for the redundant transmission.

The eNB 200 preferably determines the lowest possible transmission power value that may allow the UE 100 to decode the user data. Thus, the eNB 200 is capable of determining the transmission power value in accordance with the amount of unassigned resource (or the duplication number N in proportion to the amount of unassigned resource). Specifically, the eNB 200 is capable of using the following formula (4) to calculate the transmission power value.

T=ηP/N formula (4)

T: transmission power value/η: margin coefficient (1<η<2, for example)/P: normal transmission power/N: duplication number

According to this formula (4), the eNB 200 is capable of determining a lower transmission power value when an amount of unassigned resource is larger, and capable of determining a higher transmission power value when the amount of unassigned resource is smaller.

In step S108, the eNB 200 performs scheduling in which the unassigned resource is assigned to each UE 100. In the present embodiment, the eNB 200 assigns the unassigned resource to redundantly transmit the user data, to the UE 100-3 belonging to the second group. It is preferable that in order to obtain a good diversity effect, the eNB 200 selects, from the unassigned resources, a radio resource kept apart from the previously assigned radio resource into a frequency direction and/or a time direction, and assigns the selected radio resource to the UE 100-3.

In step S109, the eNB 200 transmits, to the UE 100, redundant transmission information used for the UE 100 to perform composite reception of and/or decode the user data redundantly transmitted by the redundant transmission control. The UE 100 receives the redundant transmission information.

The redundant transmission information includes information indicating a method of the redundant transmission control and/or information indicating the radio resource assigned to the UE 100, out of the unassigned resource.

The information indicating the method of the redundant transmission control includes the following information, for example.
Method of a determined redundant transmission control (which redundant transmission, a duplicate transmission, an error correction code, or an MCS adjustment, for example, is performed)
The transmission frequency when the duplicate transmission is performed
Error correction transmission scheme (method of being multiplied by the error correction code such as single multiplication/more-than-one multiplication)
Error correction coding scheme (a coding rate, a coding scheme (a turbo code, and a type of error correction code such as other codes))
MCS information indicating a value associated with the MCS when the MCS adjustment is performed

Further, the information indicating the radio resource includes information indicating a location (such as a subframe number and a number of a resource block) of the assigned radio resource, for example.

It is noted that the redundant transmission information may include transmission power information indicating the transmission power value.

The eNB 200 is capable of transmitting, to the UE 100, the redundant transmission information by broadcast or by unicast. For example, the eNB 200 transmits, to the individual UEs 100, control information (DCI: Downlink Control Information) including the redundant transmission information such as the MCS information. Alternatively, the eNB 200 may inform, by broadcast, the redundant transmission information into MIB (Master Information Block) or SIB (System Information Block), and transmit, to the individual UEs 100, information indicating that the UE 100 is a UE 100 on which the redundant transmission control performs.

In step S110, the UE 100 transmits, to the eNB 200, a response to the redundant transmission information. The eNB 200B receives the response.

When being capable of receiving the redundant transmission information, the UE 100 transmits an acknowledgment (Ack) to the eNB 200, and when not being capable of correctly receiving the redundant transmission information, the UE 100 transmits a negative acknowledgment (Nack) to the eNB 200.

Further, on the basis of the redundant transmission information, the UE 100 that receives the redundant transmission information performs controls to receive the user data transmitted with a transmission power lower than the normal transmission power.

In step S111, the eNB 200 determines whether or not to receive the acknowledgment (Ack) from all the UEs 100 on which to perform the redundant transmission control. When receiving the acknowledgment from all the UEs 100 (subject UEs 100) on which to perform the redundant transmission control (when “YES”), the eNB 200 executes a process in step S113. On the other hand, when not receiving the acknowledgment from a subject UE 100, the eNB 200 executes a process in step S112.

In step S112, the eNB 200 retransmits the redundant transmission information to the UE 100 from which the eNB 200 does not receive the Ack. That is, the eNB 200 retransmits the redundant transmission information to the UE 100 from which the eNB 200 receives the Nack and the UE 100 from which the eNB 200 is not capable of receiving the response.

In step S113, the eNB 200 transmits, instead of transmitting the user data with the normal transmission power, the user data to each UE 100 with the low transmission power. Each UE 100 receives the user data.

Specifically, the eNB 200 uses a normal amount of radio resource to transmit the user data with a low transmission power to the UE 100-1 belonging to the first group. That is, the eNB 200 transmits the user data with a low transmission power, to the UE 100 that is located near a center side of a cell and that has a small pathloss. On the other hand, the eNB 200 redundantly transmits the user data with a low transmission power, to the UE 100 that is located at an end of a cell and that has a large pathloss.

The UE 100-1 performs composite reception of and decodes the user data transmitted with a low transmission power. On the other hand, the UE 100-3 performs composite reception of and decodes the user data redundantly transmitted with a low transmission power, by using the redundant transmission information.

On the other hand, each of the UE 100-1 and the UE 100-3 transmits predetermined data to the eNB 200 with a normal transmission power.

Thereafter, when the number of UEs 100 that start the connection with the cell and/or the number of UEs 100 that end the communication with the eNB 200 exceed a threshold value, the eNB 200 performs control to newly determine the value of the low transmission power and the method of the redundant transmission control. That is, when determining to newly categorize the groups categorized on the basis of the pathloss, the eNB 200 newly starts the process in step S101. Alternatively, during a predetermined time zone (midnight, for example) or when the number of UEs 100 that establish the connection with the eNB 200 exceeds a threshold value, the eNB 200 may omit the process in step S101 and newly start the process in step S102.

(First Modification of First Embodiment)

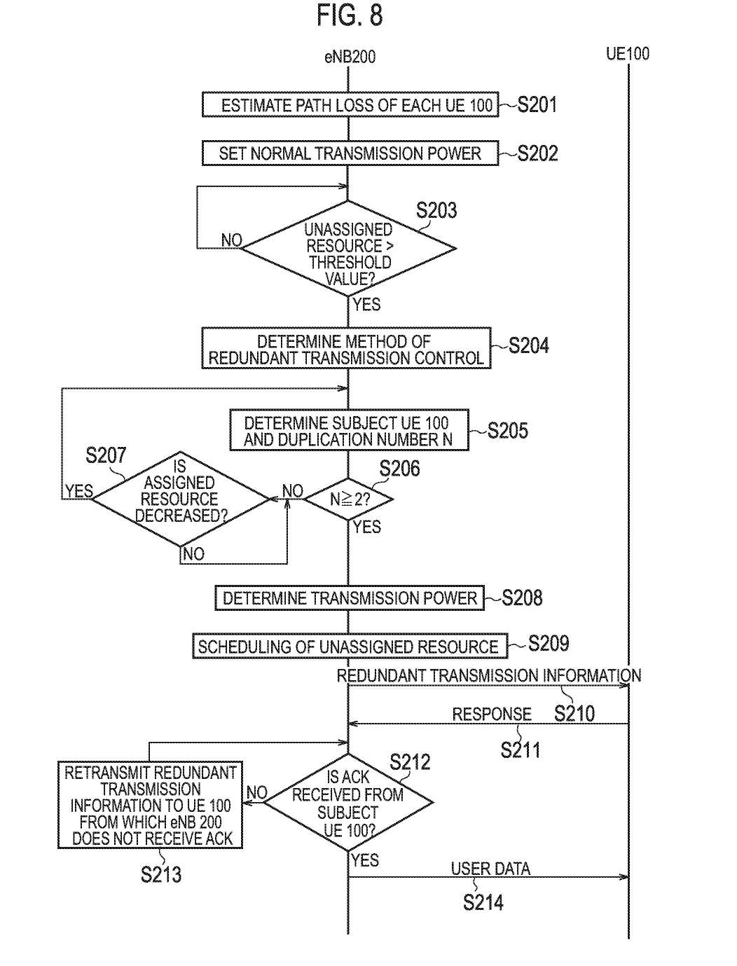

Next, a mobile communication system according to a first modification of the first embodiment will be described by using FIG. 8. FIG. 8 is an explanatory diagram for describing one example of an operation of the eNB 200 according to the first modification of the present embodiment. It is noted that a description will be provided while focusing on a portion different from the above-described embodiment, and a description of a similar portion will be omitted, where necessary.

In the above-described embodiment, the normal transmission power is the previously fixed transmission power; however, in the present modification, the normal transmission power is a transmission power set in consideration of the pathloss.

As shown in FIG. 8, in step S201, similarly to step S103, the eNB 200 estimates the pathloss from the eNB 200 to the UE 100.

In step S202, the eNB 200 sets a transmission power corresponding to a maximum pathloss to the normal transmission power. Specifically, the eNB 200 sets a transmission power allowing the UE 100 having the maximum pathloss, out of the pathloss of each UE 100 estimated in step S201, to receive the information from the eNB 200.

Steps S203 to S214 correspond to steps S101 and S103 to S113 of the first embodiment.

(Second Modification of First Embodiment)

Next, a mobile communication system according to a second modification of the first embodiment will be described. It is noted that description will be provided while focusing on a portion different from the above-described embodiment and first modification, and description of a similar portion will be omitted, where necessary.

In the present modification, a case will be described where the eNB 200 transmits, in addition to the user data, a reference signal (such as a CRS and a CSI-RS) from the eNB 200 with a low transmission power.

For example, the eNB 200 determines to transmit the reference signal with a low transmission power (a third transmission power) in a predetermined time zone such as midnight when the number of UEs 100 that perform the communication decreases. The value of the transmission power of the reference signal may be the same as or different from the low transmission power with which the user data is transmitted. The eNB 200 informs, by broadcast, that the reference signal is transmitted with the low transmission power. At that time, the eNB 200 may inform the information on the radio resource used for transmitting the reference signal with the low transmission power and/or the transmission power information indicating the transmission power value.

Next, a case will be described where the eNB 200 transmits a reference signal (that is, a reference signal used for measuring a CQI) for a downlink channel estimation, with a low transmission power.

When receiving a report of the CQI from the UE 100 after transmitting the reference signal used for measuring the CQI with the low transmission power, the eNB 200 stores whether the reported CQI is a CQI measured on the basis of the reference signal transmitted with the normal transmission power or a CQI measured on the basis of the reference signal transmitted with the low transmission power. For example, when a time at which the UE 100 measures the CQI matches a time at which the reference signal is transmitted with the low transmission power on the basis of a measurement time included in the report of the CQI, the eNB 200 determines on the basis of the reference signal transmitted with the low transmission power that the CQI is measured. The eNB 200 records, on the basis of the determination, an identifier of the measured UE 100 and which transmission power is used to transmit the reference signal which is based to measure the CQI.

It is noted that the eNB 200 may receive from the UE 100, together with the report of the CQI, information indicating that the CQI is measured on the basis of the reference signal transmitted with the low transmission power to thereby perform the determination.

Next, a case will be described where the eNB 200 redundantly transmits the user data to the UE 100 that measures the CQI on the basis of the reference signal transmitted with the low transmission power.

When receiving, from the UE 100, the CQI based on the reference signal transmitted with the low transmission power, the eNB 200 determines, on the basis of the low transmission power together with the CQI, the MCS for the redundant transmission control.

For example, when performing the redundant transmission by the duplicate transmission or the error correction code, the eNB 200 determines the value associated with the MCS in accordance with the E-SINR calculated from the CQI based on the reference signal transmitted with the normal transmission power to determine the MCS. On the other hand, when determining the MCS by the E-SINR calculated from the CQI based on the reference signal transmitted with the low transmission power, the eNB 200 determines the value associated with the MCS in accordance with the E-SINR calculated by adding a correction value (+3 dB, for example) with which the E-SINR is ameliorated, to the calculated E-SINR.

When performing the redundant transmission by adjustment of the MCS, the eNB 200, as described in the above-described first embodiment, determines the value associated with the MCS in accordance with the E-SINR calculated by adding a correction value (−3 dB, for example) to the E-SINR calculated from the CQI based on the reference signal transmitted with the normal transmission power to determine the MCS. On the other hand, when determining the MCS by the E-SINR calculated from the CQI based on the reference signal transmitted with the low transmission power, the eNB 200 determines the value associated with the MCS, in accordance with the E-SINR calculated from the CQI, to determine the MCS. That is, the eNB 200 determines the MCS without adding the correction value to the calculated E-SINR.

Thus, the eNB 200 is capable of determining the MCS on the basis of the transmission power of the reference signal together with the reported CQI.

(Summary of First Embodiment)

In the present embodiment, when the amount or the ratio of unassigned resource exceeds a threshold value, the eNB 200 performs redundant transmission control in which the unassigned resource is used to redundantly transmit user data, with a low transmission power instead of transmitting the user data with a normal transmission power. Thus, the eNB 200 transmits the user data with the low transmission power to enable power saving of the eNB 200. Further, the eNB 200 redundantly transmits the user data by using the unassigned resource, and thus, the UE 100 is capable of receiving and decoding the user data even when the transmission power decreases. Therefore, it is possible to realize power saving of the eNB 200 while suppressing a decrease in communication quality.

Further, the user data is transmitted with the low transmission power, and thus, it is possible to decrease an interference given by the eNB 200. For example, it is possible to decrease an interference given by the eNB 200 to a UE 100 within a cell managed by an adjacent eNB 200 adjacent to the eNB 200.

In the present embodiment, the eNB 200 determines the value of the low transmission power, in accordance with the amount of unassigned resource. Thus, the eNB 200 is capable of adjusting the value of the low transmission power, in accordance with the amount of unassigned resource, and thus, the eNB 200 is capable of flexibly performing the redundant transmission control in accordance with a condition.

In the present embodiment, as the redundant transmission control, the eNB 200 performs control to transmit the user data in a duplicate manner, or control to transmit, by using the error correction code, the user data in which the level of redundancy is increased than the user data transmitted with the normal transmission power. Thus, the eNB 200 is capable of performing the redundant transmission control, and thus, it is possible to suppress a decrease in communication quality and to realize power saving of the eNB 200.

In the present embodiment, the eNB 200 performs, before starting the redundant transmission, control to transmit, to the UE 100, the redundant transmission information used for the UE 100 to decode the user data redundantly transmitted by the redundant transmission control. Further, in the present embodiment, the redundant transmission information includes information indicating a method of the redundant transmission control and/or information indicating the radio resource assigned to the UE 100, out of the unassigned resource. Thus, the UE 100 is capable of performing composite reception and/or decoding the user data even the user data transmitted with the low transmission power on the basis of the redundant transmission information, and thus, it is possible to restrain a decrease in communication quality.

In the present embodiment, a reference signal for downlink channel estimation is transmitted with a low transmission power lower than the transmission power used when the redundant transmission control is not performed. When receiving, from the UE 100, a CQI based on the reference signal transmitted with the low transmission power, the eNB 200 determines, on the basis of the low transmission power together with the CQI, the MCS for the redundant transmission control. Thus, the eNB 200 transmits the reference signal with the low transmission power, and thus, it is possible to realize further power saving of the eNB 200. The eNB 200 determines the MCS in consideration of the reference signal being transmitted with the low transmission power, and thus, it is possible restrain a decrease in communication quality while realizing power saving of the eNB 200.

In the present embodiment, when a plurality of UEs 100 connect with the cell, the eNB 200 divides the plurality of UEs 100 into a plurality of groups in accordance with each pathloss from the eNB 200 to each of the plurality of UEs 100. The eNB 200 determines the value of the low transmission power in each of the plurality of groups and/or the method of the redundant transmission control therein. This eliminates a need of the eNB 200 to determine the value of the low transmission power and/or the method of the redundant transmission control for individual UEs 100, and thus, it is possible to decrease a calculation amount for the redundant transmission control. As a result, it is possible to realize power saving of the eNB 200.

In the present embodiment, when the number of UEs 100 that start the connection with the cell and/or the number of UEs 100 that end the communication with the eNB 200 exceed a threshold value, the eNB 200 newly determines the value of the low transmission power and/or the method of the redundant transmission control. Thus, the value of the low transmission power and/or the method of the redundant transmission control is determined in accordance with a change in condition of the UEs 100 constituting the group, and thus, it is possible to realize power saving of the eNB 200 while appropriately suppressing a decrease in communication quality.

### Other Embodiments

As described above, the present invention has been described with the embodiments. However, it should not be understood that those descriptions and drawings constituting a part of the present disclosure limit the present invention. From this disclosure, a variety of alternate embodiments, examples, and applicable techniques will become apparent to one skilled in the art.

For example, in the above-described embodiment, the eNB 200 determines whether or not to perform the redundant transmission control; however, this is not limiting. For example, an upper device (MME) of the eNB 200 may determine whether or not to perform the redundant transmission control. The eNB 200 redundantly transmits the user data with the low transmission power in accordance with an instruction from the upper device. Further, the upper device may apply an instruction for the redundant transmission control (an instruction such as a method of the redundant transmission control, a UE 100 on which to perform the redundant transmission control, and the value of the low transmission power, for example) to the eNB 200.

For example, a large cell eNB 200 that manages a large cell may manage a small cell, and notify a small cell eNB 200 (an eNB 200 not having a control plane, for example) located within the large cell of an instruction for the redundant transmission control. The small cell eNB 200 transmits user data, with the low transmission power, to a subordinate UE 100, on the basis of the notified instruction. In this case, the large cell eNB 200 may transmit the redundant transmission information of the small cell eNB 200, to the UE 100 subordinate to the small cell eNB 200.

Further, in the above-described embodiment, the eNB 200 redundantly transmits user data, as predetermined information, with a low transmission power; however the present invention is not limited thereto. For example, the eNB 200 may include control information into an SIB and then perform redundant transmission with a low transmission power. Further, the eNB 200 may redundantly transmit control information transmitted to the UE 100 by using a PDCCH, with a low transmission power. In this case, the eNB 200 may increase an aggregation level corresponding to a CCE (Control Channel Element) number to redundantly transmit the control information.

Further, in the above-described embodiment, the eNB 200 determines the transmission power value (value of a second transmission power), in accordance with the amount of unassigned resource; however, this is not limiting. For example, the eNB 200 may determine the transmission power value, in accordance with the pathloss. Specifically, the eNB 200 may determine a lower transmission power value as the pathloss is smaller, and determine a higher transmission power value as the pathloss is larger.

Further, in the above-described embodiment, the order for the determination of the method of the redundant transmission control (step S103), the determination of the duplication number N (steps S104 to S106), the determination of the transmission power (step S107) and the like may be changed, where necessary. For example, the eNB 200 may determine the method of the redundant transmission control after determining the duplication number N and determining the transmission power. Further, the eNB 200 may omit a process (step S103, step S107 or the like) regarding an item already determined by a capability or the like of the eNB 200 (such as the value of the low transmission power, and the method of the redundant transmission control). The eNB 200 may previously inform, by broadcast, the redundant transmission information on the already determined item before determining to perform the redundant transmission information.

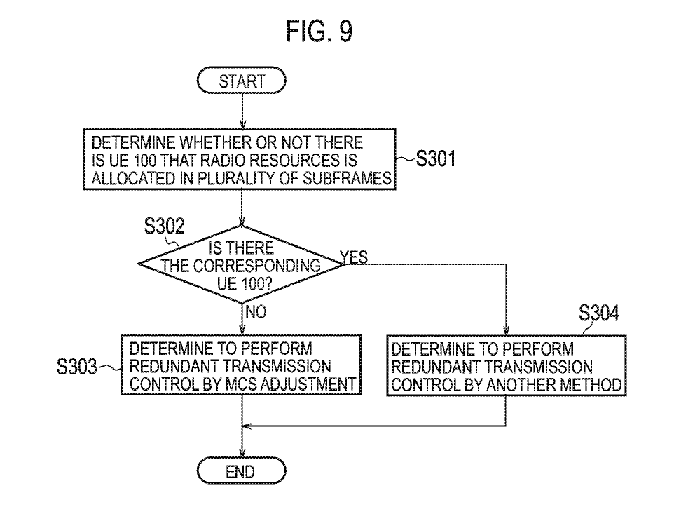

Further, in the above-described embodiment, there is no particular limitation to a method of determining the method of the redundant transmission control; however, for example, in principle, the eNB 200 performs the redundant transmission by the adjustment of the MCS, when a predetermined condition (steps S301 and S302 described later) is satisfied, the eNB 200 may use a method of another redundant transmission control to perform the redundant transmission. A specific method will be described by using FIG. 9, below. FIG. 9 is an explanatory diagram for describing one example of an operation of the eNB 200 according to another embodiment.

Firstly, the eNB 200 determines to perform redundant transmission control of user data, and then, assigns an unassigned resource to a UE 100 on which to perform the redundant transmission control.

Next, as shown in FIG. 9, in steps S301 and S302, the eNB 200 determines whether or not there is a UE 100 having a radio resource previously assigned to the UE 100 and a radio resource assigned to the UE 100, out of the unassigned resource, in a plurality of subframes.

When there is no the corresponding UE 100 (when “NO”), the eNB 200 executes a process in step S303. That is, when the radio resource assigned to the UE 100 (the previously assigned radio resource and the radio resource assigned out of the unassigned resource) is located within one subframe, the eNB 200 executes the process in step S303. On the other hand, when there is the corresponding UE 100 (when “YES”), the eNB 200 executes a process in step S304. That is, when there are the radio resources assigned to the UE 100 in a plurality of subframes, the eNB 200 executes the process in step S304.

In step S303, the eNB 200 determines to perform the redundant transmission control by the adjustment of the MCS. The eNB 200 performs transmission, by broadcast, with including into redundant control information MIB or SIB indicating to perform the redundant transmission control by the adjustment of the MCS.

On the other hand, in step S304, the eNB 200 determines to perform the redundant transmission control by another method. The eNB 200 determines to perform the redundant transmission, for example, by duplicate transmission, and performs transmission, by broadcast, with including into redundant control information MIB or SIB indicating the determined redundant transmission control.

Thereafter, the eNB 200 transmits predetermined information to the UE 100 by the redundant transmission method determined in step S303 or step S304.

It is noted that the eNB 200 that executes the process in step S303 performs, as the redundant transmission control, control to transmit the predetermined information by decreasing the value associated with the MCS. When the assigned radio resource is located in one subframe, the eNB 200 is capable of notifying, by using the existing control information (DCI), the UE 100 of the value corresponding to the MCS of the subframe, which eliminates a need to transmit additional control information to the UE 100. This enables the eNB 200 to omit the transmission of the additional control information, resulting in reduction of the radio resource used.

In addition, the aforementioned embodiment has described an example in which the present invention is applied to the LTE system. However, the present invention is not limited to the LTE system, and may also be applied to systems other than the LTE system.

It is noted that the entire content of Japanese Patent Application No. 2013-218423 (filed on Oct. 21, 2013) is incorporated in the present specification by reference.

### INDUSTRIAL APPLICABILITY

According to the invention-based base station, it is possible to realize power saving of the base station while suppressing a decrease in communication quality.

[Appendant 1]

A base station managing a cell, wherein

the base station is capable of controlling to transmit, with a first transmission power, predetermined information to a user terminal connected with the cell,

when an amount or a ratio of an unassigned resource exceeds a threshold value, the unassigned resource being a radio resource capable of being used for transmitting the predetermined information and being not yet assigned to a terminal, the base station performs, with a second transmission power lower than the first transmission power, redundant transmission control in which the predetermined information is redundantly transmitted by using the unassigned resource, and

the predetermined information is control information or user data.

[Appendant 2]

The base station according to claim 1, wherein

the controller determines, in accordance with the amount of unassigned resource, a value of the second transmission power.

[Appendant 3]

The base station according to claim 1, wherein

the redundant transmission control is transmitting the predetermined information in a duplicate manner, transmitting, by using an error correction code, the predetermined information in which the level of redundancy is increased than the predetermined information transmitted with the first transmission power, or transmitting the predetermined information by decreasing a value associated with an MCS.

[Appendant 4]

The base station according to claim 1, wherein

when a radio resource previously assigned to the user terminal for transmitting the predetermined information, and a radio resource assigned to the user terminal, out of the unassigned resource are located within one subframe, as the redundant transmission control, a value associated with an MCS is decreased and the predetermined information is transmitted.

[Appendant 5]

The base station according to claim 1, wherein

the base station transmits, before the redundant transmission is started, redundant transmission information used for the user terminal to receive and/or decode the redundantly transmitted predetermined information, to the user terminal.

[Appendant 6]

The base station according to claim 5, wherein

the redundant transmission information includes information indicating a method of the redundant transmission control and/or information indicating a radio resource assigned to the user terminal, out of the unassigned resource.

[Appendant 7]

The base station according to claim 1, wherein

the controller transmits a reference signal for a downlink channel estimation with a third transmission power lower than a transmission power used when the redundant transmission control is not performed, and

when receiving channel quality information based on the reference signal transmitted with the third transmission power from the user terminal, the controller determines, on the basis of the third transmission power together with the channel quality information, an MCS for the redundant transmission control.

[Appendant 8]

The base station according to claim 1, wherein

when a plurality of user terminals including the user terminal are connected with the cell, the controller divides the plurality of user terminals into a plurality of groups, in accordance with each pathloss to each of the plurality of user terminals from the base station, and

the controller determines a value of the second transmission power in each of the plurality of groups and/or a method of the redundant transmission control therein.

[Appendant 9]

The base station according to claim 8, wherein

when the number of user terminals that start connection with the cell and/or the number of user terminals that end communication with the base station exceed a threshold value, the controller newly determines a value of the second transmission power and/or and a method of the redundant transmission control.

[Appendant 10]

A processor provided in a base station that manages a cell, wherein

the processor is capable of controlling to transmit, with a first transmission power, control information or predetermined information that is user data to a user terminal connected with the cell, and when an amount or a ratio of an unassigned resource exceeds a threshold value, the unassigned resource being a radio resource capable of being used for transmitting the predetermined information, the processor performs, with a second transmission power lower than the first transmission power, redundant transmission control in which the predetermined information is redundantly transmitted by using the unassigned resource.

[Appendant 11]

A terminal connected to a cell managed by a base station, wherein

the terminal receives redundant transmission information transmitted from the base station, and

the terminal receives on the basis of the received redundant transmission information, predetermined information redundantly transmitted from the base station.

1. A base station managing a cell, comprising
a transmitter configured to be capable of transmitting, with a first transmission power, predetermined information to a user terminal connected with the cell, and
a controller configured to control the base station, wherein,
when an amount or a ratio of an unassigned resource exceeds a threshold value, the unassigned resource being a radio resource capable of being used for transmitting the predetermined information and being not yet assigned to a terminal, the controller performs, with a second transmission power lower than the first transmission power, redundant transmission control in which the predetermined information is redundantly transmitted by using the unassigned resource, and
the predetermined information is control information or user data.

2. The base station according to claim 1, wherein
the controller determines, in accordance with the amount of unassigned resource, a value of the second transmission power.

3. The base station according to claim 1, wherein
the redundant transmission control is transmitting the predetermined information in a duplicate manner, transmitting, by using an error correction code, the predetermined information in which the level of redundancy is increased than the predetermined information transmitted with the first transmission power, or transmitting the predetermined information by decreasing a value associated with an MCS.

4. The base station according to claim 1, wherein
when a radio resource previously assigned to the user terminal for transmitting the predetermined information, and a radio resource assigned to the user terminal, out of the unassigned resource are located within one subframe, as the redundant transmission control, a value associated with an MCS is decreased and the predetermined information is transmitted.

5. The base station according to claim 1, wherein
the transmitter transmits, before the redundant transmission is started, redundant transmission information used for the user terminal to receive and/or decode the redundantly transmitted predetermined information, to the user terminal.

6. The base station according to claim 5, wherein
the redundant transmission information includes information indicating a method of the redundant transmission control and/or information indicating a radio resource assigned to the user terminal, out of the unassigned resource.

7. The base station according to claim 1, wherein
the transmitter transmits a reference signal for a downlink channel estimation with a third transmission power lower than a transmission power used when the redundant transmission control is not performed, and
when receiving channel quality information based on the reference signal transmitted with the third transmission power from the user terminal, the controller determines, on the basis of the third transmission power together with the channel quality information, an MCS for the redundant transmission control.

8. The base station according to claim 1, wherein
when a plurality of user terminals including the user terminal are connected with the cell, the controller divides the plurality of user terminals into a plurality of groups, in accordance with each pathloss to each of the plurality of user terminals from the base station, and
the controller determines a value of the second transmission power in each of the plurality of groups and/or a method of the redundant transmission control therein.

9. The base station according to claim 8, wherein
when the number of user terminals that start connection with the cell and/or the number of user terminals that end communication with the base station exceed a threshold value, the controller newly determines a value of the second transmission power and/or and a method of the redundant transmission control.

10. A processor for controlling a base station that manages a cell, wherein
the processor is capable of controlling to transmit, with a first transmission power, predetermined information that is control information or user data to a user terminal connected with the cell, and
when an amount or a ratio of an unassigned resource exceeds a threshold value, the unassigned resource being a radio resource capable of being used for transmitting the predetermined information, the processor performs, with a second transmission power lower than the first transmission power, redundant transmission control in which the predetermined information is redundantly transmitted by using the unassigned resource.

11. A terminal connected to a cell managed by a base station, comprising:
a receiver configured to receive redundant transmission information transmitted from the base station, and
the receiver receives on the basis of the received redundant transmission information, predetermined information redundantly transmitted from the base station.
